(19) United States
(12) Patent Application Publication
(10) Pub. No.: US 2012/0148936 A1
(43) Pub. Date: Jun. 14, 2012

(54) INORGANIC AND/OR ORGANIC ACID-CONTAINING CATALYST INK AND USE THEREOF IN THE PRODUCTION OF ELECTRODES, CATALYST-COATED MEMBRANES, GAS DIFFUSION ELECTRODES AND MEMBRANE ELECTRODE UNITS

(75) Inventors: Oemer Uensal, Mainz (DE); Sigmar Braeuninger, Hemsbach (DE)

(73) Assignee: BASF SE, Ludwigshafen (DE)

(21) Appl. No.: 13/391,543

(22) PCT Filed: Aug. 18, 2010
(86) PCT No.: PCT/EP2010/062003

§ 371 Date: Feb. 21, 2012

(30) Foreign Application Priority Data
Aug. 21, 2009 (EP) 09168366.4

(51) Int. Cl. H01M 8/10

(52) U.S. Cl. 429/483

(57) ABSTRACT

Catalyst ink comprising one or more catalyst materials, a solvent component and at least one acid, an electrode comprising at least one catalyst ink according to the present invention, a membrane-electrode assembly comprising at least one electrode according to the invention or comprising at least one catalyst ink according to the present invention, a fuel cell comprising at least one membrane-electrode assembly according to the invention and also a process for producing a membrane-electrode assembly according to the present invention.

The present invention relates to a catalyst ink comprising one or more catalyst materials, a solvent component and at least one acid, an electrode comprising at least one catalyst ink according to the present invention, a membrane-electrode assembly comprising at least one electrode according to the invention or comprising at least one catalyst ink according to the present invention, a fuel cell comprising at least one membrane-electrode assembly according to the invention and also a process for producing a membrane-electrode assembly according to the present invention.

Polymer electrolyte membrane fuel cells (PEM fuel cells) are known in the prior art. At present, virtually exclusively polymers modified with sulfonic acid are used as proton-conducting membranes in them. Perfluorinated polymers are predominantly used here. A prominent example is Nafion® from DuPont. A relatively high water content, typically from 4 to 20 molecules of water per sulfonic acid group, is necessary in the membrane in order to achieve proton conduction. The necessary water content and also the stability of the polymer in combination with acidic water and the reaction gases hydrogen and oxygen usually limits the operating temperature of the PEM fuel cell stack to from 80 to 100° C. Under superatmospheric pressure, the operating temperature can be increased to >120° C. Otherwise, relatively high operating temperatures cannot be achieved without a decrease in performance of the fuel cell.

However, for reasons relating to the characteristics of the system, operating temperatures above 100° C. are desirable in the fuel cell. The activity of the noble metal-based catalysts comprised in the membrane-electrode assembly is significantly better at high operating temperatures. Particularly when using reformates from hydrocarbons, significant amounts of carbon monoxide are comprised in the reformer gas and these usually have to be removed by means of a complicated gas work-up or gas purification. At high operating temperatures, the tolerance of the catalysts toward the CO impurities increases.

Furthermore, heat is evolved during operation of fuel cells. However, the cooling of these systems to below 80° C. can be very complicated. Depending on the power output, the cooling facilities can be made significantly simpler. This means that in fuel cells which are operated at temperatures above 100° C., the heat given off can be utilized considerably better and the fuel cell system efficiency can thus be increased by power-heat coupling. To achieve these temperatures, membranes having new conductivity mechanisms are generally used. A very promising approach for realizing a fuel cell which operates at operating temperatures of >100° C., in general from 120° C. to 180° C., with no or very little humidification is a fuel cell type in which the conductivity of the membrane is based on the content of a liquid acid which is electrostatically bound to the polymer framework of the membrane and takes over the proton conductivity even in a virtually dry state of the membrane above the boiling point of water without additional humidification of the operating gases. Such a fuel cell type as is known in the prior art is generally referred to as High-Temperature Polymer Electrolyte Membrane Fuel Cell (HTM fuel cell). Polybenzimidazole (PBI) in particular is known as material for such membranes which are impregnated with, for example, phosphoric acid as liquid electrolyte.

To obtain a very high efficiency of membranes impregnated with an acidic liquid electrolyte, the electrodes used in a membrane-electrode assembly or in a fuel cell have to be matched to the circumstances in the fuel cell membrane. It is important, inter alia, that the introduction of the liquid electrolyte (the acid) into and the distribution thereof in the membrane-electrode assembly is optimal in order to ensure a good proton conductivity.

M. Uchida et al., J. Electrochem. Soc., Vol. 142, No. 2, pages 463 to 468, relates to a process for producing a catalyst layer in electrodes of polymer electrolyte fuel cells, which comprises the preparation of a perfluorosulfonate ionomer (PFSI) colloid. Here, both a good network of PFSI and a uniform distribution of PFSI on Pt particles is said to be achieved. This is achieved by colloid formation of the PFSI chains in specific organic solvents. Here, the PFSI colloids are selectively adsorbed on carbon agglomerates having highly dispersed Pt particles on the surface, and a catalyst paste is subsequently produced. In the examples in M. Uchida, PFSI solutions are firstly produced by adding commercially available Nafion® solutions in isopropanol or Flemion® solutions in ethanol to specific organic solvents, namely esters, ethers, acetone, ketones, amines, carboxylic acids, alcohols and nonpolar solvents. Among the mixtures obtained, the mixtures in which PFSIs are present in colloidal form are selected. The catalytically active component Pt-C is added to these mixtures. A paste is subsequently produced from the mixtures by ultrasonic treatment. The pastes are used for producing gas diffusion electrodes and further for producing membrane-electrode assemblies and for producing fuel cells. Here, the membrane-electrode assemblies or the fuel cells have membranes in the form of Nafion® or Flemion®, i.e. perfluorosulfonate ionomers.

WO 2005/076401 relates to membranes for fuel cells which are composed of at least one polymer which comprises nitrogen atoms and whose nitrogen atoms are chemically bound to central atoms of polybasic inorganic oxo acids or derivatives thereof. In a preferred embodiment, the polymer and the oxo acid derivative are crosslinked to form a framework which is capable of taking up dopants to give proton-conducting properties. A suitable dopant is, for example, phosphoric acid. WO 2005/076401 further relates to a fuel cell, where the gas diffusion electrodes of the fuel cell are loaded with the dopant in such a way that they represent a dopant reservoir for the membrane, with the membrane becoming proton-conducting by uptake of the dopant after the action of pressure and heat and is attached in a proton-conducting fashion to the gas diffusion electrodes. According to WO 2005/076401 it is the object of WO 2005/076401 to provide membranes for fuel cells which display homogeneous uptake of dopants and retention thereof. According to the example, loading of the electrodes with the dopant is carried out by doping the finished electrodes with the dopant, preferably phosphoric acid.

DE 103 01 810 A1 relates to a membrane-electrode assembly for polymer electrolyte fuel cells which has an operating temperature up to 250° C. and comprises at least two sheet-like gas diffusion electrodes and a polymer membrane which is arranged in between and comprising at least one basic polymer and a dopant with which the gas diffusion electrodes are loaded in such a way that they represent a dopant reservoir for the polymer membrane, with the polymer membrane being attached firmly and in a proton-conducting manner to the gas diffusion electrodes by means of the dopant after the action of pressure and heat. The proton-conducting bond between electrode and electrolyte is generally ensured by means of phosphoric acid. For this purpose, the electrodes are impregnated with phosphoric acid before assembly of the cell. According to the examples, a commercially available electrode is impregnated with concentrated phosphoric acid at room temperature under reduced pressure.

WO 2006/005466 A1 discloses gas diffusion electrodes having improved proton conduction between an electrocatalyst present in the catalyst layer and an adjacent polymer electrolyte membrane, which can be used at operating temperatures to above the boiling point of water and ensure a lastingly high gas permeability, and also the corresponding production processes. According to WO 2006/005466 the gas diffusion electrodes are loaded with dopants so that they represent a dopant reservoir for the membrane. Preference is given to using phosphoric acid as dopant in WO 2006/005466. According to the examples in WO 2006/005466, the production of a membrane-electrode assembly based on gas diffusion electrodes is carried out in such a way that the gas diffusion electrodes are impregnated with concentrated phosphoric acid.

DE 101 55 543 A1 discloses proton-conducting polymer electrolyte membranes comprising at least one base material and at least one dopant which is the reaction product of an at least dibasic inorganic acid with an organic compound, with the reaction product having an acidic hydroxyl group, or the condensation product of this compound with a polybasic acid. Phosphoric acid itself is not comprised in the proton-conducting electrolyte membrane according to DE 101 55 543 A1. According to the examples in DE 101 55 543 A1, a membrane-electrode assembly is produced by impregnating commercially available electrodes with concentrated phosphoric acid at room temperature under reduced pressure.

Thus, according to the prior art, acid-loaded gas diffusion electrodes are produced by a subsequent acid treatment of the gas diffusion electrodes which are already loaded with catalyst material and subsequent pressing together of a suitable polymer electrolyte membrane with the gas diffusion electrodes obtained to give a membrane-electrode unit. Here, the amount and the distribution of acid (dopant) in the electrode are disadvantageous. How much acid goes into the membrane during pressing and how much acid comes out of the gas diffusion electrode during pressing cannot be defined and cannot be controlled. The distribution of the acid in the catalyst layer is greatly dependent on the nature of the catalyst layer.

It is therefore an object of the present invention to provide a catalyst ink which is suitable for producing gas diffusion electrodes, catalyst-coated membranes, membrane-electrode assemblies and fuel cells and firstly has good processing properties, an excellent distribution of the acid (dopant) in the catalyst layer which is better than in the prior art, allows controlled introduction of the amount of acid (dopant) into the catalyst layer and additionally makes possible a reproducible and reliable production process for gas diffusion electrodes, catalyst-coated membranes, membrane-electrode assemblies and fuel cells.

This object is achieved by a catalyst ink comprising:
(a) one or more catalyst materials as component A;
(b) a solvent component as component B; and
(c) at least one acid selected from the group consisting of phosphoric acid, polyphosphoric acid, sulfuric acid, nitric acid, HClO₄, organic phosphonic acids (e.g. vinylphosphonic acid), inorganic phosphonic acid, trifluoromethanesulfonic acid and mixtures thereof.

For the purposes of the present patent application, the expression “catalyst ink” refers to both catalyst inks and catalyst pastes.

The catalyst ink of the invention has numerous advantages over the catalyst inks of the prior art and over electrodes which have subsequently been doped with acid. Firstly, introduction of a controlled and suitable amount of acid into the electrode and distribution thereof in the electrode are possible.

Furthermore, a novel pore structure is produced in the catalyst layer by the presence of the acid in the catalyst ink. Since the drying temperatures of the gas diffusion electrodes are generally below the boiling point of the acid, the acid molecules become positioned between the catalyst particles.

Furthermore, improved processability of the catalyst inks can be achieved by the presence of acid. Since the acids used according to the invention are not very volatile, the catalyst ink dries more slowly during processing. This allows precise loading and reproducibility of electrode production, and mass production is made easier by the use of larger catalyst ink volumes.

Furthermore, the acids adsorbed in the catalyst layers can contribute to the proton conductivity in a membrane-electrode assembly produced with the aid of the catalyst ink of the invention.

The catalyst ink of the invention can be applied to gas diffusion layers or membranes by known standard methods, e.g. screen printing, doctor blade coating, other printing processes or spray coating.

The catalyst ink of the invention is particularly suitable for high-temperature fuel cells in which the conductivity of the membrane is based on the content of liquid acid which is electrostatically bound to the polymer framework of the membrane, with the membrane being based, in particular, on polyazoles and phosphoric acid, for example, being used as liquid electrolyte.

### Component A: Catalyst Materials

According to the present invention, the catalyst ink comprises one or more catalyst materials as component A. These catalysts materials serve as catalytically active component. Suitable catalyst materials which can be used as catalyst materials for the anode or for the cathode of a membrane-electrode assembly or a fuel cell are known to those skilled in the art. Examples of suitable catalyst materials are catalyst materials which comprise at least one noble metal as catalytically active component, with the noble metal being, in particular, platinum, palladium, rhodium, iridium, gold and/or ruthenium. These substances can also be used in the form of alloys with one another. Furthermore, the catalytically active component can comprise one or more base metals as alloying additives, with these being selected from the group consisting of chromium, zirconium, nickel, cobalt, titanium, tungsten, molybdenum, vanadium, iron and copper. In addition, the oxides of the abovementioned noble metals and/or base metals can also be used as catalyst materials.

The catalyst material can be present in the form of supported catalysts or support-free catalysts, with supported catalysts being preferred. As support materials, preference is given to using electrically conductive carbon, particularly preferably electrically conductive carbon selected from among carbon blacks, graphite and activated carbons.

The catalyst materials are generally used in the form of particles. When the catalyst materials are present as support-free catalysts, the particles (e.g. noble metal crystallites) can have average particle sizes of <5 nm, e.g. from 1 to 1000 nm, determined by means of XRD measurements. When the catalyst material is used in the form of supported catalysts, the particle size (catalytically active component + support material) is generally from 0.01 to 100 μm, preferably from 0.01 to 50 μm, particularly preferably from 0.01 to 30 μm.

In general, the catalyst ink of the invention comprises such a proportion of noble metals that the noble metal content in the catalyst layer of the electrode or membrane-electrode assembly produced by means of the catalyst ink is from 0.1 to 10.0 mg/cm², preferably from 0.2 to 6.0 mg/cm², particularly preferably from 0.2 to 3.0 mg/cm². These values can be determined by elemental analysis of a sheet-like sample.

In the production of a membrane-electrode assembly using the catalyst ink of the invention, it is usual to select a weight ratio of a membrane polymer for producing the membrane present in the membrane-electrode assembly to the catalyst material comprising at least one noble metal and optionally one or more support materials used in the catalyst ink of >0.05, preferably from 0.1 to 0.6.

In the catalyst ink of the invention, the catalyst materials (component A) are generally present in an amount of from 2 to 30% by weight, preferably from 2 to 25% by weight, particularly preferably from 3 to 20% by weight, based on the components A, B and C of the catalyst ink.

When the catalyst materials used according to the invention comprise a support material, the proportion of support material in the catalyst materials used according to the invention is generally from 40 to 90% by weight, preferably from 60 to 90% by weight. The proportion of noble metal in the catalyst materials used according to the invention is generally from 10 to 60% by weight, preferably from 10 to 40% by weight. If a base metal is used as alloying additive in addition to the noble metal, the proportion of noble metal is reduced by the respective amount of the base metal. The proportion of base metal as alloying additive, based on the total amount of metal present in the catalyst material, is usually from 0.5 to 15% by weight, preferably from 1 to 10% by weight. If oxides are used instead of the corresponding metals, the amounts indicated for the metals apply.

### Component B: Solvent Component

In general, the catalyst ink of the invention comprises from 2 to 30% by weight, preferably from 2 to 25% by weight, particularly preferably from 3 to 20% by weight, of component A and from 0.1 to 6% by weight, preferably from 0.2 to 4% by weight, particularly preferably from 0.2 to 3% by weight, of component C. This means that the catalyst ink of the invention generally comprises from 64 to 97.9% by weight, preferably from 71 to 97.8% by weight, particularly preferably from 77 to 96.8% by weight, of the solvent component, based on the total amount of the components A, B and C.

As solvent component, it is possible to use a single solvent or a mixture comprising two or more solvents in the catalyst ink of the invention. In general, an aqueous medium, preferably water, is used in the catalyst ink of the invention. In addition to or as an alternative to water, the solvent component can comprise alcohols or polyalcohols such as glycerol or ethylene glycol or organic solvents such as dimethylacetamide (DMAc), N-methylpyrrolidone (NMP) or dimethylformamide (DMF). The water, alcohol or polyalcohol content and/or content of organic solvent in the catalyst ink can be selected so as to set the rheological properties of the catalyst ink. In general, the catalyst ink of the invention comprises, apart from water, from 0 to 50% by weight of alcohol and/or from 0 to 20% by weight of polyalcohol and/or from 0 to 50% by weight of at least one organic solvent.

### Component C: at Least One Acid

As component C, the catalyst ink of the invention comprises at least one acid selected from the group consisting of phosphoric acid, polyphosphoric acid, sulfuric acid, nitric acid, HClO₄, organic phosphonic acids (e.g. vinylphosphonic acid), inorganic phosphonic acid, trifluoromethanesulfonic acid and mixtures thereof.

The at least one acid present in the catalyst ink according to the present invention is preferably at least one acid which is used as liquid electrolyte (dopant) in polymer electrolyte membranes for fuel cells. Suitable acids are known in principle to those skilled in the art, with the acids preferably being selected from the group consisting of phosphoric acid, sulfuric acid, polyphosphoric acid, vinylphosphonic acid. Particular preference is given to using phosphoric acid as acid.

Suitable acids present in a polymer electrolyte membrane of a membrane-electrode assembly or catalyst-coated membrane or fuel cell produced with the aid of the catalyst ink of the invention are mentioned below.

The acid is generally used in the catalyst ink of the invention in an amount of from 0.1 to 6% by weight, preferably from 0.2 to 4% by weight, particularly preferably from 0.2 to 3% by weight, based on the sum of the components A, B and C, which is 100% by weight.

The catalyst ink of the invention can, if appropriate, additionally comprise at least one dispersant as component D. The dispersant is generally present in an amount of from 0.1 to 4% by weight, preferably from 0.1 to 3% by weight, based on the total amount of the components A, B and C. Suitable dispersants are known in principle to those skilled in the art. A particularly preferred dispersant used as component D is at least one perfluorinated polymer, e.g. at least one tetrafluoroethylene polymer, preferably at least one perfluorinated sulfonic acid polymer, e.g. at least one sulfonated tetrafluoroethylene polymer, particularly preferably Nafion® from DuPont, Fumion® from Fumatech or Ligion® from Ionpower.

In a further preferred embodiment, the present invention therefore provides a catalyst ink according to the invention, wherein the catalyst ink further comprises a component D as dispersant:
(d) at least one perfluorinated polymer, e.g. at least one tetrafluoroethylene polymer, preferably at least one perfluorinated sulfonic acid polymer, e.g. at least one sulfonated tetrafluoroethylene polymer, particularly preferably Nafion® from DuPont, Fumion® from Fumatech or Ligion® from Ionpower.

Further suitable perfluorinated polymers are, for example, tetrafluoroethylene polymer (PTFE), polyvinylidene fluoride (PVdF), perfluoro(propyl vinyl ether) (PFA) and/or perfluoro(methyl vinyl ether) (MFA).

In addition, the catalyst ink of the invention can further comprise at least one surfactant as component E. Suitable surfactants are known to those skilled in the art. They can be surfactants which either are washed out or decompose pyrolytically after application of the catalyst ink, e.g. when the electrode produced after application of the catalyst ink is heated, e.g. to temperatures of <200° C. Preferred surfactants are selected from the group consisting of anionic surfactants and nonionic surfactants, e.g. fluoro surfactants such as surfactants of the general formula CF₃—(CF₂)ₚ—X, where p=3 to 12 and X is selected from the group consisting of —SO₃H, —PO₃H₂ and —COOH, e.g. a tetraethylammonium salt of heptadecafluoroctanoic acid. Further suitable surfactants are octylphenol poly(ethylene glycol ether)ₓ, where x can be, for example, 10, e.g. Triton® X-100 from Roche Diagnostics GmbH, nonylphenol ethoxylates, e.g. nonylphenol ethoxylates of the Tergitol® series from Dow Chemical Company, sodium salts of naphthalenesulfonic acid condensates, e.g. sodium salts of naphthalenesulfonic acid condensates of the Tamol® series from BASF SE, fluoro surfactants, e.g. fluoro surfactants of the Zonyl® series from DuPont, alkoxylation products of predominantly linear fatty alcohols, e.g. alkoxylation products of predominantly linear fatty alcohols of the Plurafac® series, e.g. Plurafac® LF 711 from BASF SE, alkoxylates of ethylene oxide or propylene oxide, e.g. alkoxylates of ethylene oxide or propylene oxide of the Pluriol® series from BASF SE, in particular polyethylene glycols of the formula HO(CH₂CH₂O)ₙH, e.g. of the Pluriol® E series from BASF SE, e.g. Pluriol® E300, and also β-naphthol ethoxylate, e.g. Lugalvan® BNO₁₂ from BASF SE.

The at least one surfactant is, if surfactant is used, usually used in an amount of from 0.1 to 4% by weight, preferably from 0.1 to 3% by weight, particularly preferably from 0.1 to 2.5% by weight, based on the components A, B and C.

The present invention therefore further provides a catalyst ink according to the invention, wherein the catalyst ink further comprises a component E:
(e) at least one surfactant, preferably selected from the group consisting of anionic surfactants, e.g. fluoro surfactants such as surfactants of the general formula CF₃—(CF₂)ₚ—X, where p=3 to 12 and X is selected from the group consisting of —SO₃H, —PO₃H₂ and —COOH, e.g. a tetraethylammonium salt of heptadecafluoroctanoic acid. Further suitable surfactants are octylphenol poly(ethylene glycol ether)ₓ, where x can be, for example, 10, e.g. Triton® X-100 from Roche Diagnostics GmbH, nonylphenol ethoxylates, e.g. nonylphenol ethoxylates of the Tergitol® series from Dow Chemical Company, sodium salts of naphthalenesulfonic acid condensates, e.g. sodium salts of naphthalenesulfonic acid condensates of the Tamol® series from BASF SE, fluoro surfactants, e.g. fluoro surfactants of the Zonyl® series from DuPont, alkoxylation products of predominantly linear fatty alcohols, e.g. alkoxylation products of predominantly linear fatty alcohols of the Plurafac® series, e.g. Plurafac® LF 711 from BASF SE, alkoxylates of ethylene oxide or propylene oxide, e.g. alkoxylates of ethylene oxide or propylene oxide of the Pluriol® series from BASF SE, in particular polyethylene glycols of the formula HO(CH₂CH₂O)ₙH, e.g. of the Pluriol® E series from BASF SE, e.g. Pluriol® E300, and β-naphthol ethoxylate, e.g. Lugalvan® BNO₁₂ from BASF SE.

In addition, the catalyst ink of the invention can further comprise polymer particles comprising one or more proton-conducting polymers as component F.

In a preferred embodiment of the present invention, the polymer particles are not present in solution in the catalyst ink but are preferably dispersed in the liquid medium of the catalyst ink.

The catalyst ink of the invention is, as mentioned above, particularly suitable for high-temperature fuel cells in which the conductivity of the membrane is based on the content of liquid acid which is electrostatically bound to the polymer framework of the membrane, with the membrane being based, in particular, on polyazoles and phosphoric acid, for example, being used as liquid electrolyte.

As a result of the polymer particles which are finely dispersed in the catalyst layer, the acid, in particular phosphoric acid, can be taken up and bound to the polymer particles present in the catalyst layer. In this way, the three-phase interfacial area (catalyst, ionomer and gas) can be increased. It has been found that a membrane-electrode assembly based on a catalyst ink according to the invention has low resistances compared to a membrane-electrode assembly based on a catalyst ink which does not contain any finely dispersed polymer.

For the present purposes, the expression “proton-conducting polymers” means that the polymers used can in combination with a liquid comprising acids or acid-comprising compounds as electrolyte conduct protons.

Suitable proton-conducting polymers are the polymers mentioned below as polymers of the polymer electrolyte membrane.

The polymer particles generally have an average particle size of 100 μm, preferably 50 μm. The particle size and particle size distribution are determined by laser light scattering using a Malvern Master Sizer® instrument.

The catalyst ink of the invention usually comprises, if the component F is present in the catalyst ink of the invention, from 1 to 50% by weight, preferably from 1 to 30% by weight, particularly preferably from 1 to 15% by weight, of the at least one proton-conducting polymer used as component F, based on the amount of catalyst material used in the ink.

The present invention therefore further provides a catalyst ink according to the invention, wherein the catalyst ink further comprises a component F:

polymer particles comprising one or more proton-conducting polymers. Suitable proton-conducting polymers have been mentioned above.

The catalyst ink of the invention is produced by simple mixing of the components A, B and C and optionally the components D, E and optionally F. Mixing can be carried out in customary mixing apparatuses known to those skilled in the art. This mixing can be carried out by all methods known to those skilled in the art in apparatuses known to those skilled in the art, e.g. in stirred reactors, ball shaking mixers or continuous mixing apparatuses, if appropriate using ultrasound. Mixing of the components of the catalyst ink is usually carried out at room temperature. However, it is also possible to mix the components of the catalyst ink in a temperature range from 0 to 70° C., preferably from 10 to 50° C.

The catalyst ink of the invention has improved processing properties which allow precise loading and reproducibility of electrode production. Furthermore, a controlled and suitable amount of acid can be introduced into the electrode and the acid adsorbed in the catalyst layers produced from the catalyst ink can contribute to proton conductivity.

The catalyst ink of the invention is employed for forming catalyst layers, in particular catalyst layers in catalyst-coated membranes (CCMs), gas diffusion electrodes (GDEs), membrane-electrode assemblies (MEAs) and fuel cells.

The catalyst layer is generally not self-supporting but is usually applied to the gas diffusion layer (GDL) and/or the proton-conducting polymer electrolyte membrane. Here, part of the catalyst layer can diffuse, for example, into the gas diffusion layer and/or the membrane to form transition layers. This can also, for example, lead to the catalyst layer being able to be considered to be part of the gas diffusion layer.

The thickness of the catalyst layer built up from the catalyst ink of the invention in a catalyst-coated membrane (CCM), gas diffusion electrode (GDE), membrane-electrode assembly (MEA) or fuel cell is generally from 1 to 1000 μm, preferably from 5 to 500 μm, particularly preferably from 10 to 300 μm. This value is an average which can be determined by measuring the layer thickness in cross section on images which can be obtained by means of a scanning electron microscope (SEM).

The present invention further provides for the use of the catalyst ink of the invention for producing a catalyst-coated membrane (CCM), a gas diffusion electrode (GDE), a membrane-electrode assembly (MEA) or a fuel cell, with the abovementioned catalyst-coated membranes, gas diffusion electrodes and membrane-electrode assemblies preferably being used in polymer electrolyte fuel cells or in PEM electrolysis.

To produce a catalyst-coated membrane (CCM), a gas diffusion electrode (GDE) or a membrane-electrode assembly (MEA), the catalyst ink is generally applied in homogeneously dispersed form to the ion-conducting polymer electrolyte membrane of the catalyst-coated membrane (CCM) or the gas diffusion layer (GDL) of a gas diffusion electrode. The production of a homogeneously dispersed ink can be carried out by means of auxiliaries known to those skilled in the art, e.g. by means of high-speed stirrers, ultrasound or ball mills.

The application of the homogeneously dispersed catalyst ink to the polymer electrolyte membrane or the gas diffusion layer can be effected by means of various techniques known to those skilled in the art. Suitable techniques are, for example, printing, spraying, doctor blade coating, rolling, brushing, painting, decal, screen printing or inkjet printing.

In general, the catalyst layer obtained by application of the catalyst ink of the invention is dried after application. Suitable drying methods are known to those skilled in the art. Examples are hot air drying, infrared drying, microwave drying, plasma processes and combinations of these methods.

The present invention further provides a catalyst-coated membrane (CCM) comprising a polymer electrolyte membrane which has an upper side and an underside, with a catalytically active layer produced by application of the catalyst ink of the invention to the polymer electrolyte membrane having been applied both to the upper side and to the underside.

The CCM of the invention is distinguished, in particular, by the specific distribution of the acid (component C of the catalyst ink of the invention) in the catalytically active layer due to the use of the catalyst ink of the invention.

Suitable polymer electrolyte membranes for the catalyst-coated membrane are known in principle to those skilled in the art. Proton-conducting polymer electrolyte membranes based on proton-conducting polymers are particularly suitable.

For the present purposes, the expression “proton-conducting polymers” means that the polymers used can in combination with a liquid comprising acids or acid-comprising compounds as electrolyte conduct protons.

Suitable polymers which in the presence of acids or acid-comprising compounds as electrolytes can conduct protons are, for example, selected from the group consisting of poly(phenylene), poly(p-xylylene), polyarylmethylene, polystyrene, polymethylstyrene, polyvinyl alcohol, polyvinyl acetate, polyvinyl ether, polyvinylamine, poly(N-vinylacetamide), polyvinylimidazole, polyvinylcarbazole, polyvinylpyrrolidine, polyvinylpyridine;

polymers having CO bonds in the main chain, for example polyacetal, polyoxymethylene, polyethers, polypropylene oxide, polyether ketone, polyesters, in particular polyhydroxyacetic acid, polyethylene terephthalate, polybutylene terephthalate, polyhydroxybenzoate, polyhydroxypropionic acid, polypivalolactone, polycaprolactone, polymalonic acid, polycarbonate;
polymers having C—S bonds in the main chain, for example polysulfide ethers, polyphenylene sulfide, polysulfones, polyether sulfone;
polymers having C—N bonds in the main chain, for example polyimines, polyisocyanides, polyetherimine, polyetherimides, polyaniline, polyaramids, polyamides, polyhydrazides, polyurethanes, polyimides, polyazoles, polyazole ether ketone, polyazines;
liquid-crystalline polymers, in particular Vectra® from Ticona GmbH, and also inorganic polymers, for example, polysilanes, polycarbosilanes, polysiloxanes, polysilicic acid, polysilicates, silicones, polyphosphazenes and polythiazyl.

Here, basic polymers are preferred, with possible basic polymers being in principle all basic polymers by means of which, after acid doping, protons can be transported. Acids which are preferably used are those which can transport protons without additional water, e.g. by means of the Grotthos mechanism.

As basic polymer for the purposes of the present invention, preference is given to using a basic polymer having at least one nitrogen, oxygen or sulfur atom, preferably at least one nitrogen atom, in a repeating unit. Furthermore, preference is given to basic polymers which comprise at least one heteroaryl group.

The repeating unit in the basic polymer comprises, in a preferred embodiment, an aromatic ring having at least one nitrogen atom. The aromatic ring is preferably a 5- or 6-membered ring which has from 1 to 3 nitrogen atoms and can be fused with another ring, in particular another aromatic ring.

In a preferred embodiment, high-temperature-stable polymers which comprise at least one nitrogen, oxygen and/or sulfur atom in one repeating unit or in different repeating units are used.

For the purposes of the present invention, a high-temperature-stable polymer is a polymer which can be operated as polymeric electrolyte in a fuel cell at temperatures above 120° C. on a long-term basis. A long-term basis means that a membrane composed of this polymer can generally be operated for at least 100 hours, preferably at least 500 hours, at least 80° C., preferably at least 120° C., particularly preferably at least 160° C., without the power, which can be measured by the method described in WO 01/18894 A2, decreasing by more than 50%, based on the initial power.

For the purposes of the present invention, all abovementioned polymers can be used individually or as a mixture (blend). Here, particular preference is given to blends comprising polyazoles and/or polysulfones. The preferred blend components here are polyether sulfone, polyether ketone and polymers modified with sulfonic acid groups, as described in DE 100 522 42 and DE 102 464 61.

Furthermore, polymer blends comprising at least one basic polymer and at least one acidic polymer, preferably in a weight ratio of from 1:99 to 99:1, (known as acid-base polymer blends) have also been found to be useful for the purposes of the present invention. In this context, particularly useful acidic polymers comprise polymers which have sulfonic acid and/or phosphoric acid groups. Acid-base polymer blends which are very particularly suitable for the purposes of the invention are described, for example, in EP 1 073 690 A1.

The proton-conducting polymers are very particularly preferably polyazoles or mixtures of polyazoles which are doped with acid, preferably phosphoric acid, to make them proton-conducting.

A basic polymer based on polyazole particularly preferably comprises recurring azole units of the general formula (I) and/or (II) and/or (III) and/or (IV) and/or (V) and/or (VI) and/or (VII) and/or (VIII) and/or (IX) and/or (X) and/or (XI) and/or (XII) and/or (XIII) and/or (XIV) and/or (XV) and/or (XVI) and/or (XVII) and/or (XVIII) and/or (XIX) and/or (XX) and/or (XXI) and/or (XXII):

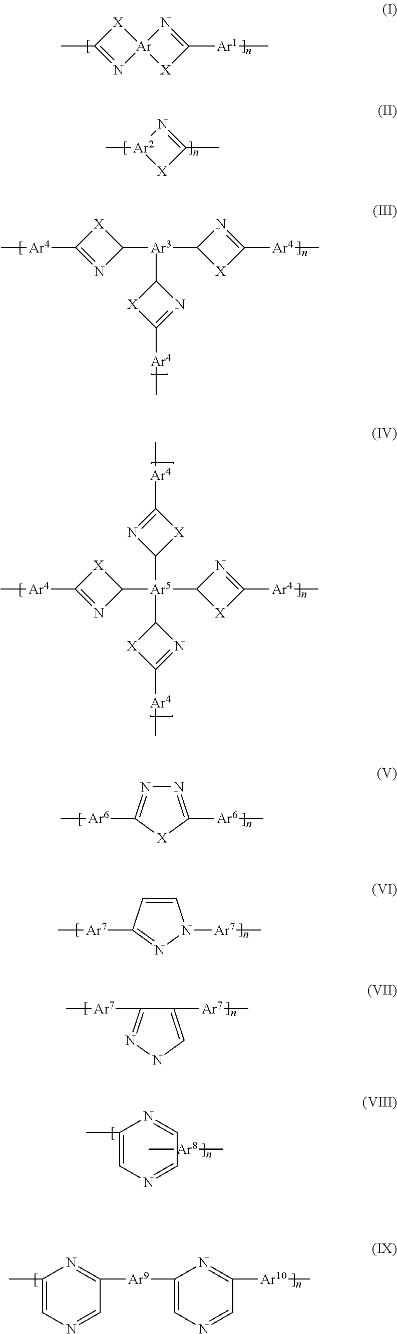

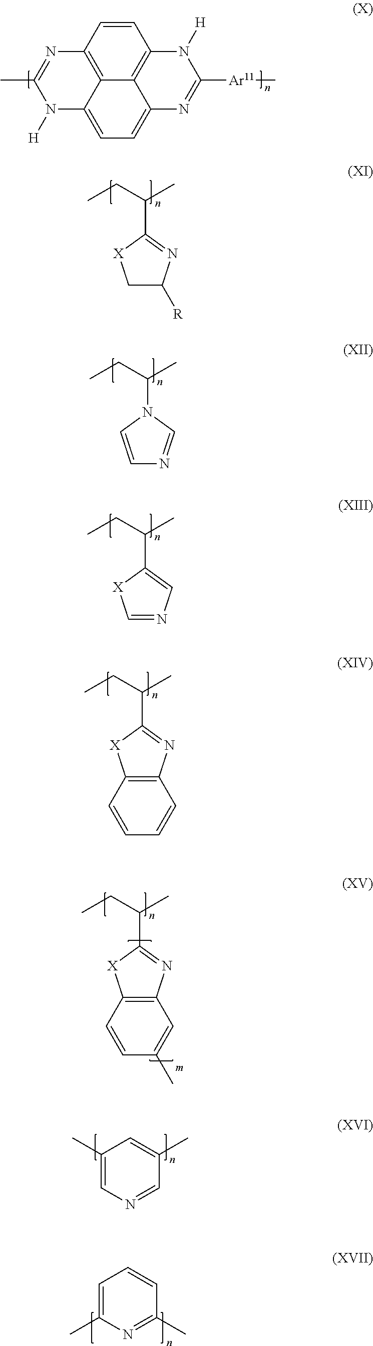

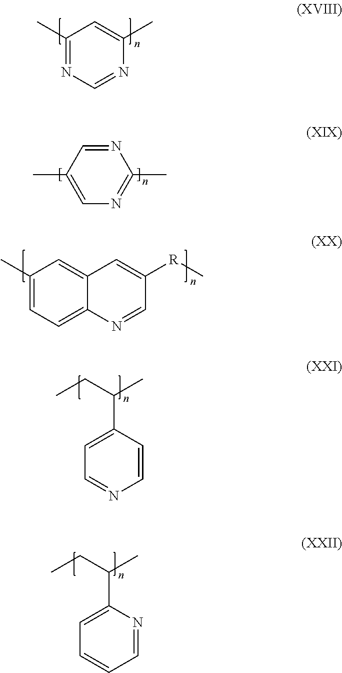

where
the radicals Ar are identical or different and are each a tetravalent aromatic or heteroaromatic group which may be monocyclic or polycyclic,
the radicals Ar¹ are identical or different and are each a divalent aromatic or heteroaromatic group which may be monocyclic or polycyclic,
the radicals Ar² are identical or different and are each a divalent or trivalent aromatic or heteroaromatic group which may be monocyclic or polycyclic,
the radicals Ar³ are identical or different and are each a trivalent aromatic or heteroaromatic group which may be monocyclic or polycyclic,
the radicals Ar⁴ are identical or different and are each a trivalent aromatic or heteroaromatic group which may be monocyclic or polycyclic,
the radicals Ar⁴ are identical or different and are each a tetravalent aromatic or heteroaromatic group which may be monocyclic or polycyclic,
the radicals Ar⁶ are identical or different and are each a divalent aromatic or heteroaromatic group which may be monocyclic or polycyclic,
the radicals Ar⁷ are identical or different and are each a divalent aromatic or heteroaromatic group which may be monocyclic or polycyclic,
the radicals Ar⁸ are identical or different and are each a trivalent aromatic or heteroaromatic group which may be monocyclic or polycyclic,
the radicals Ar⁹ are identical or different and are each a divalent or trivalent or tetravalent aromatic or heteroaromatic group which may be monocyclic or polycyclic,
the radicals Ar¹⁰ are identical or different and are each a divalent or trivalent aromatic or heteroaromatic group which may be monocyclic or polycyclic,
the radicals Ar¹¹ are identical or different and are each a divalent aromatic or heteroaromatic group which may be monocyclic or polycyclic,
the radicals X are identical or different and are each oxygen, sulfur or an amino group which bears a hydrogen atom, a group having from 1 to 20 carbon atoms, preferably a branched or unbranched alkyl or alkoxy group, or an aryl group as further radical,
the radicals R are identical or different and are each hydrogen, an alkyl group or an aromatic group and in formula (XX) an alkylene group or an aromatic group, with the proviso that R in formula (XX) is not hydrogen, and
n, m are each an integer 10, preferably 100.

Preferred aromatic or heteroaromatic groups are derived from benzene, naphthalene, biphenyl, diphenyl ether, diphenylmethane, diphenyldimethylmethane, bisphenone, diphenyl sulfone, quinoline, pyridine, bipyridine, pyridazine, pyrimidine, pyrazine, triazine, tetrazine, pyrrole, pyrazole, anthracene, benzopyrrole, benzotriazole, benzooxathiadiazole, benzooxadiazole, benzopyridine, benzopyrazine, benzopyrazidine, benzopyrimidine, benzotriazine, indolizine, quinolizine, pyridopyridine, imidazolopyrimidine, pyrazinopyrimidine, carbazole, azeridine, phenazine, benzoquinoline, phenoxazine, phenothiazine, aziridizine, benzopteridine, phenanthroline and phenanthrene, which may optionally be substituted.

Here, the substitution pattern of Ar¹, Ar⁴, Ar⁶, Ar⁷, Ar⁸, Ar⁹, Ar¹⁰ and Ar¹¹ can be any desired pattern. In the case of phenylene, for example, Ar¹, Ar⁴, Ar⁶, Ar⁷, Ar⁸, Ar⁹, Ar¹⁰ and Ar¹¹ can be, independently of one another, ortho-, meta- and para-phenylene. Particularly preferred groups are derived from benzene and biphenylene, which may optionally be substituted.

Preferred alkyl groups are alkyl groups having from 1 to 4 carbon atoms, e.g. methyl, ethyl, n-propyl, i-propyl and t-butyl groups.

Preferred aromatic groups are phenyl or naphthyl groups. The alkyl groups and the aromatic groups may be monosubstituted or polysubstituted.

Preferred substituents are halogen atoms, e.g. fluorine, amino groups, hydroxy groups or C₁-C₄-alkyl groups, e.g. methyl or ethyl groups.

The polyazoles can in principle have differing recurring units which differ, for example, in their radical X. However, the respective polyazoles preferably have exclusively identical radicals X in a recurring unit.

In a particularly preferred embodiment, the polyazoles comprise recurring azole units of the formula (I) and/or (II).

The polyazoles are, in one embodiment, polyazoles comprising recurring azole units in the form of a copolymer or a blend comprising at least two units of the formulae (I) to (XXII) which are different from one another. The polymers can be present as block copolymers (diblock, triblock), random copolymers, periodic copolymers and/or alternating polymers.

The number of recurring azole units in the polymer is preferably an integer 10, particularly preferably ≧100.

In a further preferred embodiment, polyazoles which comprise recurring units of the formula (I) and in which the radicals X are identical within the recurring units are used.

Further preferred polyazoles are selected from the group consisting of polybenzimidazole, poly(pyridine), poly(pyrimidine), polyimidazole, polybenzothiazole, polybenzoxazole, polyoxadiazole, polyquinoxaline, polythiadiazole and poly(tetrazapyrene).

In a particularly preferred embodiment, the polyazole comprise recurring benzimidazole units. Suitable polyazoles having recurring benzimidazole units are shown below:

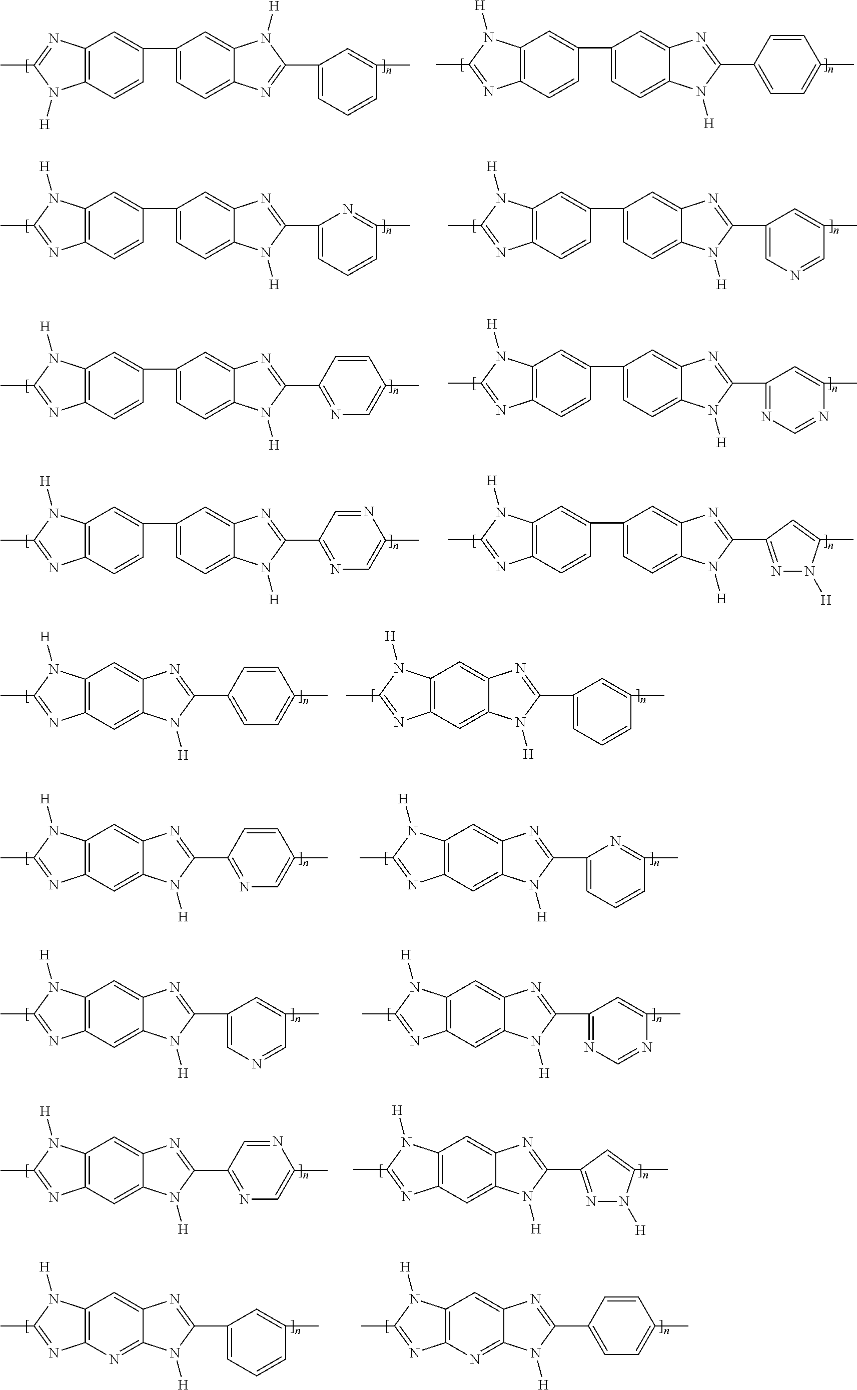

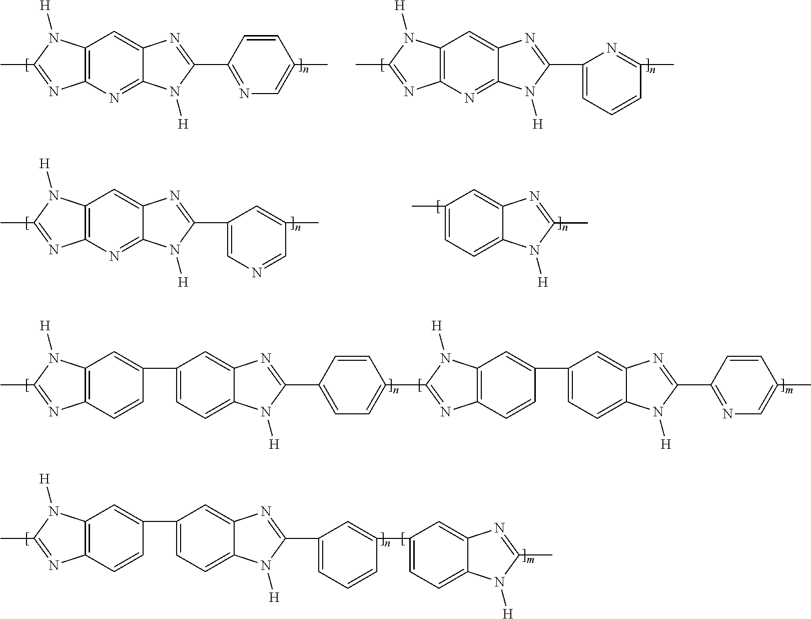

where n and m are integers ≧10, preferably ≧100;
where the phenylene or heteroarylene units present in the above-mentioned benzimidazole units may be substituted by one or more F atoms.

The polyazole particularly preferably has repeating units of the following formula

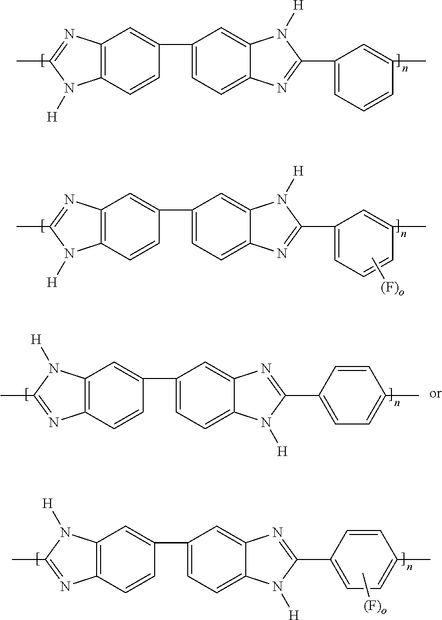

where n is an integer 10, preferably 100, and o is 1, 2, 3 or 4.

The polyazoles, preferably the polybenzimidazoles, generally have a high molecular weight. Measured as intrinsic viscosity, the molecular weight is preferably at least 0.2 dl/g, particularly preferably from 0.8 to 10 dl/g, very particularly preferably from 1 to 10 dl/g. The viscosity eta i, also referred to as intrinsic viscosity, is calculated from the relative viscosity eta rel according to the following equation

eta i=(2.303×log eta rel)/concentration. The concentration is given in g/100 ml. The relative viscosity of the polyazoles is determined by means of a capillary viscometer from the viscosity of the solution at 25° C., with the relative viscosity being calculated from the corrected run-out times for solvent t0 and solution t1 according to the following equation eta rel =t1/t0. The conversion into eta i is carried out according to the above relationship by the procedure in “Methods in Carbohydrate Chemistry”, Volume IV, Starch, Academic Press, New York and London, 1964, page 127.

Preferred polybenzimidazoles are commercially available, for example, under the trade name Celazol® PBI (from PBI Performance Products Inc.).

In a very particularly preferred embodiment, the proton-conducting polymer is pPBI (poly-2,2′-p-(phenylene)-5,5′-dibenzimidazole and/or F-pPBI (poly-2,2′-p-(perfluorophenylene)-5,5′-dibenzimidazole), which is proton-conducting after doping with acid.

The polymer electrolyte membranes are generally produced by methods known to those skilled in the art, e.g. by casting, spraying or doctor blade application of a solution or dispersion which comprises the components used for producing the polymer electrolyte membrane to a support. Suitable supports are all customary support materials known to those skilled in the art, e.g. polymer films such as polyethylene terephthalate (PET) films or polyether sulfone films, or metal tape, with the membrane subsequently being able to be detached from the metal tape.

The polymer electrolyte membrane used in the catalyst-coated membranes (CCMs) of the invention generally has a layer thickness of from 20 to 2000 μm, preferably from 30 to 1500 μm, particularly preferably from 50 to 1000 μm.

The present invention further provides a gas diffusion electrode (GDE) comprising a gas diffusion layer (GDL) and a catalytically active layer produced by applying the catalyst ink of the invention to the gas diffusion layer (GDL).

As in the case of the CCM of the invention, the GDE of the invention is likewise distinguished, in particular, by the specific distribution of the acid (component C of the catalyst ink of the invention) in the catalytically active layer, due to the use of the catalyst ink of the invention.

As gas diffusion layers, it is usual to use sheet-like, electrically conductive and acid-resistant structures. These include, for example, graphite fiber papers, carbon fiber papers, woven graphite fabrics and/or papers which are made conductive by addition of carbon black. A fine dispersion of the gas or liquid streams is achieved by means of these layers.

Furthermore, it is also possible to use gas diffusion layers which comprise a mechanically stable support material which is impregnated with at least one electrically conductive material, e.g. carbon (for example carbon black). Support materials which are particularly suitable for these purposes comprise fibers, for example in the form of nonwovens, papers or woven fabrics, in particular carbon fibers, glass fibers or fibers comprising organic polymers, for example polypropylene, polyester (polyethylene terephthalate), polyphenylene sulfide or polyether ketones. Further details of such diffusion layers may be found, for example, in WO 97/20358.

The gas diffusion layers preferably have a thickness in the range from 80 μm to 2000 μm, particularly preferably from 100 μm to 1000 μm, very particularly preferably from 150 μm to 500 μm.

Furthermore, the gas diffusion layers advantageously have a high porosity. This is preferably in the range from 20% to 80%.

The gas diffusion layers can comprise customary additives. These include, inter alia, fluoropolymers, for example polytetrafluoroethylene (PTFE), and surface-active substances.

In one embodiment, the gas diffusion layer can be composed of a compressible material. For the purposes of the present invention, a compressible material has the property that the gas diffusion layer can be pressed by means of applied pressure to at least half, preferably at least one third, of its original thickness without losing its integrity. This property is generally displayed by gas diffusion layers composed of woven graphite fabrics and/or paper which has been made conductive by addition of carbon black.

The catalytically active layer in the gas diffusion electrode of the invention is based on the catalyst ink of the invention.

Here, the catalytically active layer is applied to the gas diffusion electrode by means of the abovementioned catalyst ink of the invention. The method of application of the catalyst ink to the gas diffusion electrode corresponds to the method of application of the catalyst ink to the catalyst-coated membrane, which has been described comprehensively above.

The present invention further provides a membrane-electrode assembly comprising a polymer electrolyte membrane which has an upper side and an underside, wherein a catalytically active layer produced on the basis of the catalyst ink of the invention has been applied both to the upper side and to the underside and a gas diffusion layer has been applied to each catalytically active layer.

Suitable polymer electrolyte membranes are the polymer electrolyte membranes mentioned above in respect of the catalyst-coated membrane. Suitable gas diffusion layers are the gas diffusion layers mentioned above in respect of the gas diffusion electrode of the invention. The catalytically active layer displays the features mentioned in respect of the CCM and the GDL.

The production of the membrane-electrode assemblies of the invention is in principle known to those skilled in the art. The various constituents of the membrane-electrode assembly are usually placed on top of one another and joined to one another by means of pressure and heat, with lamination usually being carried out at a temperature of from 10 to 300° C., preferably from 20 to 200° C., and at a pressure of generally from 1 to 1000 bar, preferably from 3 to 300 bar.

The membrane-electrode assembly can, for example, be produced by firstly producing two gas diffusion electrodes (GDEs), with suitable GDEs having been mentioned above, and pressing the gas diffusion electrodes together with the polymer electrolyte membrane at the abovementioned temperatures and pressures.

As an alternative, a catalyst-coated membrane (CCM) can be produced first, with suitable CCMs having been mentioned above, and this can be pressed together with two gas diffusion layers at the abovementioned pressures and temperatures.

An advantage of the membrane-electrode assemblies of the invention is that they make it possible for a fuel cell to be operated at temperatures above 120° C. This is true for gaseous and liquid fuels such as hydrogen-comprising gases which are, for example, produced in a preceding reforming step from hydrocarbons. As oxidant, it is possible to use, for example, oxygen or air.

A further advantage of the membrane-electrode assemblies of the invention is that in operation above 120° C. even when using pure platinum catalysts, i.e. without a further alloying constituent, they have a high tolerance toward carbon monoxide. At temperatures of 160° C., it is possible for, for example, more than 1% of carbon monoxide to be comprised in the fuel gas without this leading to an appreciable reduction in the performance of the fuel cell.

Furthermore, it is a substantial advantage of the membrane-electrode assemblies of the invention that a good and homogeneous distribution of acid in the catalyst layer is achieved by use of the catalyst ink of the invention in the production of the catalytically active layer of the membrane-electrode assembly. This is achieved, in particular, by the catalyst ink of the invention comprising at least one acid selected from among phosphoric acid, polyphosphoric acid, sulfuric acid, nitric acid, HClO₄, organic phosphonic acids (e.g. vinylphosphonic acid), inorganic phosphonic acid, trifluoromethanesulfonic acid and mixtures thereof as component C.

The membrane-electrode assemblies of the invention can be operated in fuel cells without the fuel gases and the oxidants having to be humidified despite the high possible operating temperatures. The fuel cell nevertheless operates stably and the membrane does not lose its conductivity. This simplifies the entire fuel cell system and brings additional cost savings since the water circuit is simplified. Furthermore, the behavior of the fuel cell system at temperatures below 0° C. is also improved as a result.

Furthermore, the membrane-electrode assemblies of the invention allow the fuel cell to be cooled without problems to room temperature and below and then be taken into operation again without the performance suffering.

Furthermore, the membrane-electrode assemblies according to the present invention display, as mentioned above, a high long-term stability. This makes it possible to provide fuel cells which likewise have a high long-term stability. Furthermore, the membrane-electrode assemblies of the invention have an excellent heat and corrosion resistance and a comparatively low gas permeability, in particular at high temperatures. A decrease in the mechanical stability and the structural integrity, in particular at high temperatures, is reduced or avoided in the membrane-electrode assemblies of the invention.

In addition, the membrane-electrode assemblies of the invention can be produced inexpensively and simply.

The present invention further provides a fuel cell comprising at least one membrane-electrode assembly according to the invention. Suitable fuel cells and their components are known to those skilled in the art.

Since the power of a single fuel cell is often too low for many applications, preference is given, for the purposes of the present invention, to combining a plurality of single fuel cells via separator plates to form a fuel cell stack. The separator plates should, if appropriate, together with further sealing materials, seal the outline of the cathode and the anode from the outside and form a seal between the gas spaces of the cathode and the anode. For this purpose, the separator plates are preferably juxtaposed in a sealing fashion with the membrane-electrode assembly. The sealing effect can be increased further by pressing of the combination of separator plates and membrane-electrode assembly.

The separator plates preferably each have at least one gas channel for reaction gases, which gas channels are advantageously arranged on the sides facing the electrodes. The gas channels should make distribution of the reactant fluids possible.

Owing to the high long-term stability of the membrane-electrode assemblies according to the present invention, the fuel cell of the invention also has a high long-term stability. The fuel cell of the invention can usually be operated continuously over long periods, e.g. more than 5000 hours, at temperatures of more than 120° C. using dry reaction gases without an appreciable deterioration in performance being observed. The power densities which can be achieved are high even after such a long time.

Here, the fuel cells of the invention display a high open circuit voltage even after a long time, for example more than 5000 hours, with the open circuit voltage preferably being at least 900 mV after this time. To measure the open circuit voltage, the fuel cell is operated in a no-current state with a water flow to the anode and an airflow to the cathode. The measurement is carried out by switching the fuel cell from a current of 0.2 A/cm² to the no-current state and then recording the open circuit voltage for 5 minutes. The value after 5 minutes is the corresponding open circuit potential. The measured values of the open circuit voltage are based on a temperature of 160° C. In addition, the fuel cell preferably displays a low gas crossover after this time. To measure the crossover, the anode side of the fuel cell is supplied with hydrogen (5 l/h) and the cathode is supplied with nitrogen (5 l/h). The anode serves as reference electrode and counterelectrode, while the cathode serves as working electrode. The cathode is placed at a potential of 0.5 V and the hydrogen diffusing through the membrane is oxidized at the cathode at a rate limited by mass transfer. The resulting current is a measure of the hydrogen permeation rate. The current is <3 mA/cm², preferably <2 mA/cm², particularly preferably <1 mA/cm², in a 50 cm² cell. The measured values of the H₂ crossover are based on a temperature of 160° C.

The present invention further provides for the use of the catalyst ink of the invention for producing catalytically active layers of a membrane-electrode assembly.

The following examples illustrate the invention.

### EXAMPLE

2 parts of Nafion ionomer in H₂O (10 wt %) EW1100 (from DuPont), 3.5 parts of H₂O and 0.25 part of phosphoric acid (85%) were placed in a glass flask and stirred by means of a magnetic stirrer. One part of Pt/C catalyst is then weighed in and slowly mixed into the batch while stirring. The batch was stirred further for about 5-10 minutes at room temperature by means of the magnetic stirrer. The sample was then treated with ultrasound until the amount of energy introduced was 0.015 KWh. This value was based on a batch size of 20 g.

The catalyst-coated gas diffusion electrode (GDE) was produced by screen printing on the anode side and the cathode side. The catalyst ink comprising polymer powder was used only for cathode GDEs.

For the cell tests, the MEA (membrane-electrode assembly) composed of prefabricated GDEs and Celtec-P membrane was pressed together with a spacer to 75% of the starting thickness at 140° C. for 30 seconds. The active surface area of the MEA was 45 cm². The specimens were subsequently installed in the cell block and then tested at 160° C. using H₂ (anode stoichiometry 1.2) and air (cathode stoichiometry 2). The performance of the specimens at 1 A/cm² is shown below.

TABLE
performance of the specimen at 1 A/cm²

| | Power density |
|---|---|
| | [mW/cm²] @ 1 A/cm² |
| Specimen | 400 |

1. A membrane-electrode assembly comprising a proton-conducting polymer electrolyte membrane comprising:
a polyazole or a mixture of polyazoles which are doped with phosphoric acid to make them proton-conducting;
an upper side;
an underside;
an upper catalytically active layer applied to the upper side;
a lower catalytically active layer applied to the underside;
an upper gas diffusion layer applied to the upper catalytically active layer; and
a lower gas diffusion layer applied to the lower catalytically active layer,
wherein the upper and lower catalytically active layer are produced from a catalyst ink comprising:
(a) a catalyst material;
(b) a solvent; and
(c) an acid selected from the group consisting of phosphoric acid, polyphosphoric acid, sulfuric acid, nitric acid, HClO₄, an organic phosphonic acid, an inorganic phosphonic acid, trifluoromethanesulfonic acid and mixtures thereof.

2. The membrane-electrode assembly of claim 1, wherein the catalyst material comprises a noble metal as a catalytically active component.

3. The membrane-electrode assembly of claim 1, wherein the solvent is an aqueous medium.

4. The membrane-electrode assembly of claim 1, wherein the acid is phosphoric acid.

5. The membrane-electrode assembly of claim 1, wherein the catalyst ink comprises:
(a) from 2 to 30% by weight of the catalyst material;
(b) from 64 to 97.9% by weight of the solvent B; and
(c) from 0.1 to 6% by weight of the acid,
wherein the sum of the catalyst material, the solvent, and the acid is 100% by weight.

6. The membrane-electrode assembly of claim 1, wherein the catalyst ink further comprises:
(d) a perfluorinated polymer.

7. The membrane-electrode assembly of claim 6, wherein the catalyst ink comprises the perfluorinated polymer in an amount of from 0.1 to 4% by weight based on the total amount of the catalyst material, the solvent, and the acid in the catalyst ink.

8. The membrane-electrode assembly of claim 1, wherein the catalyst ink further comprises:
(e) a surfactant.

9. A catalyst-coated membrane, comprising a proton-conducting polymer electrolyte membrane comprising:
a polyazole or a mixture of polyazoles which are doped with phosphoric acid to make them proton-conducting;
an upper side;
an underside;
an upper catalytically active layer applied the upper side; and
a lower catalytically active layer applied to the underside;
wherein the upper and lower catalytically active layer are produced from a catalyst ink comprising:
(a) a catalyst material;
(b) a solvent; and
(c) an acid selected from the group consisting of phosphoric acid, polyphosphoric acid, sulfuric acid, nitric acid, HClO₄, an organic phosphonic acid, an inorganic phosphonic acid, trifluoromethanesulfonic acid and mixtures thereof.

10. A fuel cell, comprising the membrane-electrode assembly of claim 1.

11. The membrane-electrode assembly of claim 2, wherein the catalytically active component further comprises a base metal as an alloying additive.

12. The membrane-electrode assembly of claim 1, wherein the catalyst material of the catalyst ink comprises at least one selected from the group consisting of a noble metal, an oxide of a noble metal, a base metal as an alloying additive, and a oxide of a base metal as an alloying additive.

13. The membrane-electrode assembly of claim 2, wherein the catalytically active component is in the form of a supported catalyst.

14. The membrane-electrode assembly of claim 2, wherein the catalytically active component is in the form of a support-free catalyst.

15. The membrane-electrode assembly of claim 6, wherein the perfluorinated polymer is a perfluorinated sulfonic acid polymer.

16. The membrane-electrode assembly of claim 6, wherein the catalyst ink further comprises:
(e) a surfactant.
